(19) United States
(12) Patent Application Publication
(10) Pub. No.: US 2023/0232450 A1
(43) Pub. Date: Jul. 20, 2023

(54) ENERGY DETECTION THRESHOLD DESIGN FOR WIRELESS NETWORK

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Hao XU, Beijing (CN)

(21) Appl. No.: 18/009,696

(22) PCT Filed: Jul. 28, 2020
(86) PCT No.: PCT/CN2020/105038

§ 371 Date: Dec. 9, 2022

(51) Int. Cl. H04W 74/08; H04W 72/50

(52) U.S. Cl. CPC H04W 74/0808; H04W 72/50

(57) ABSTRACT

Aspects presented herein may enhance the determination of ED threshold to improve the channel access probability of the UE and the base station. In one aspect, a UE or a base station determines an ED threshold for a transmission, where the ED threshold is based on a characteristic of the transmission, a channel, or the UE/base station excluding a maximum transmit power of the UE or the base station. The UE or the base station determines whether an energy on the channel is less than the determined ED threshold. The UE or the base station transmits on the channel when the energy is determined to be less than the ED threshold.

### BACKGROUND

### Technical Field

The present disclosure relates generally to communication systems, and more particularly, to a wireless communication involving energy detection threshold.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The value of the ED threshold for the UE may be determined based on the UE or the base station's maximum transmitting power depending on whether there is a COT sharing. For example, when there is no COT sharing, the value of the ED threshold may be determined based on the UE's maximum transmitting power, whereas when there is a COT sharing, the value of the ED threshold may be determined based on the base station's maximum transmitting power, etc. Similarly, the value of the ED threshold for the base station may be determined based on the base station's maximum transmitting power. This may reduce the channel access probability for the UE or the base station as the UE or the base station may be configured with the same ED threshold regardless the priority of the data transmitted by the UE or the base station, the channel used by the UE or the base station, and/or type of transmission, etc.

Aspects presented herein may enhance the determination of the ED threshold to improve the channel access probability of the UE and the base station. The UE may determine the ED threshold based on a characteristic of the transmission, a channel and/or the UE/base station.

In an aspect of the disclosure, a method, a computer-readable medium, and an apparatus are provided at a UE. The apparatus determines an ED threshold for a transmission, where the ED threshold is based on a characteristic of the transmission, a channel, or the UE excluding a maximum transmit power of the UE. The apparatus determines whether an energy on the channel is less than the determined ED threshold. The apparatus transmits to abase station on the channel when the energy is determined to be less than the ED threshold.

In an aspect of the disclosure, a method, a computer-readable medium, and an apparatus are provided at a base station. The apparatus determines an ED threshold for a transmission, where the ED threshold is based on a characteristic of the transmission, a channel, or the base station excluding a maximum transmit power of the base station. The apparatus determines whether an energy on the channel is less than the determined ED threshold. The apparatus transmits to a UE on the channel when the energy is determined to be less than the ED threshold.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of determining the availability of a channel based on the ED threshold.

FIG. 5 is a flowchart of a method of wireless communication.

FIG. 6 is a diagram illustrating an example of a hardware implementation for an example apparatus.

FIG. 7 is a flowchart of a method of wireless communication.

FIG. 8 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

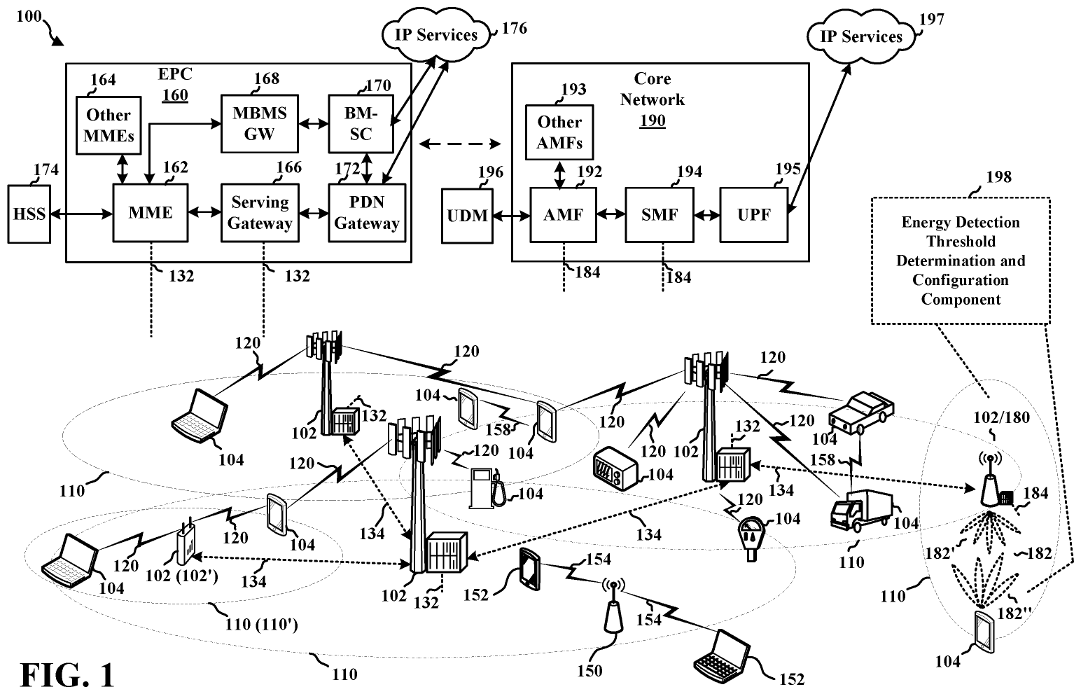

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

In certain aspects, the UE 104 and/or the base station 102, 180 may include an Energy Detection Threshold Determination and Configuration Component 198 configured to determine an ED threshold for the UE 104 or the base station 102, 180. The Energy Detection Threshold Determination and Configuration Component 198 may determine the ED threshold based on one or more of the followings: the service type of the network (e.g., URLLC, eMBB, mMTC), the CAPC, the channel type, the COT for the transmission, the actual transmission power at which the UE or the base station 102, 180 is configured to transmit the transmission, whether the transmission is a retransmission, and/or the importance of the package, etc.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from abase station 102 to a UE 104. The communication links 120 may use multiple-input and multiple-output (IMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (P SBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicens e d frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and aUser Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

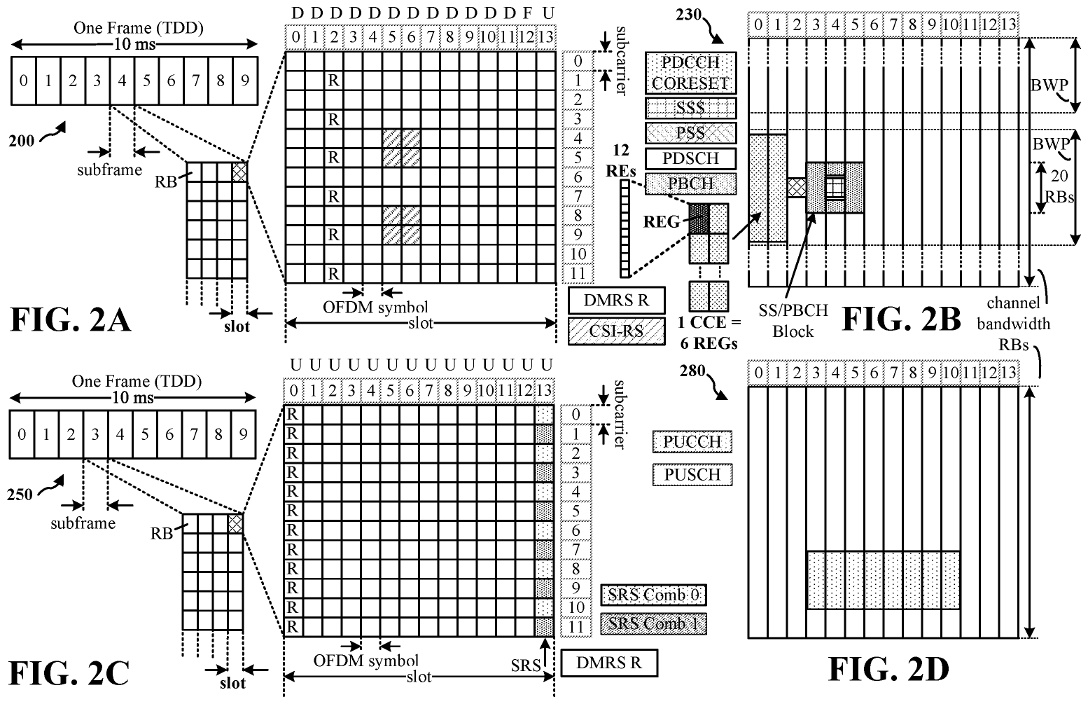

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2^{μ} slots/subframe. The subcarrier spacing and symbol length/duration are a function of the numerology. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

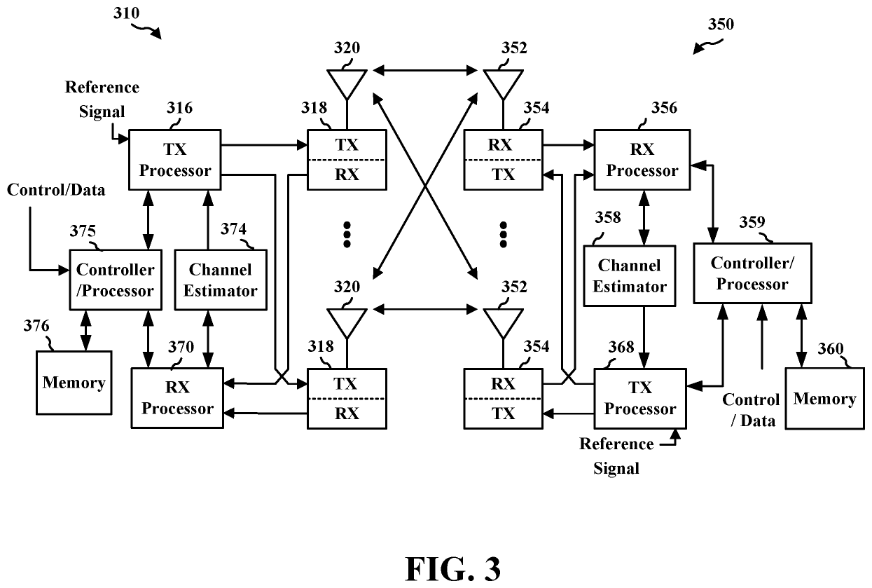

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the Energy Detection Threshold Determination and Configuration Component 198 of FIG. 1.

At least one of the TX processor 316, the RX processor 370, and the controller/processor 375 may be configured to perform aspects in connection with the Energy Detection Threshold Determination and Configuration Component 198 of FIG. 1.

A network, such as the 5G NR in unlicensed spectrum (NR-U), may operate using unlicensed spectrum and integrate the unlicensed spectrum into the network. This may enable the base station and the UE to communicate (e.g., transmit uplink and/or receive downlink data) in unlicensed bands. For a network operating with unlicensed spectrum (e.g., NR-U), channel access in both downlink and uplink may rely on a listen-before-talk (LBT) procedure. Under the LBT procedure, the UE and/or the base station may perform clear channel assessment (CCA) before using a channel, where the CCA may use Energy detection (ED) to detect the presence or absence of other signal(s) within the channel. For example, prior to use a channel for communication, the UE or the base station may detect whether there is any user(s) (e.g., user signal(s)) occupying the channel (or whether a channel is idle), and the UE or the base station may quit the channel if the UE or the base station detects the presence of other signal(s) within the channel in order to avoid interference to other user(s). The ED technique may enable the UE or the base station to detect the energy level on multiple sub-bands of the communications channel. For example, the UE or the base station may measure the energy level of one or more channel, and may determine whether the one or more channel is available by comparing the measured energy level to an ED threshold value. The technique may be used by the UE or the base station without prior knowledge on whether there is a primary user (e.g., primary user signal) within the channel. The parameters for the UE to perform the LBT procedure, such as the type, duration and/or CAA parameters, etc., may be configured by the base station (e.g., DCI, RRC configuration, etc.).

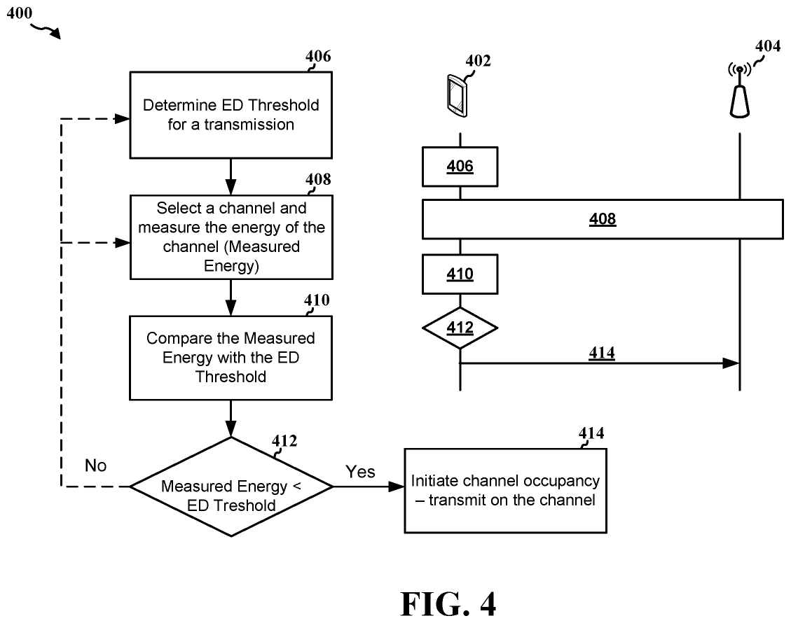

FIG. 4 is a diagram 400 illustrating an example of determining the availability of a channel based on the ED technique. Note that while the examples below use the UE for illustrations, the same ED technique is also applicable to the base station, and shall be construe as part of the disclosure. At 406, a UE 402 may determine an ED threshold (e.g., in dB) for a transmission. At 408, the UE may select at least one channel from a base station 404, and the UE 402 may measure the energy of the channel. At 410, the UE 402 may compare the measure energy of the channel with the ED threshold. At 412, the UE 402 may determine whether the measured energy is lower or less than the ED threshold. If the measured energy is not lower or less (e.g., is higher) than the ED threshold, the UE 402 may determine that the channel is occupied or the noise/interference level within the channel is too high, and the UE 402 may decide not use the channel. The UE 402 may go back to step 406 to determine another ED threshold for a transmission, and/or the UE 402 may go back to step 408 and select another channel and repeat the same process until an available channel is detected. On the other hand, if the measured energy is lower or less than the ED threshold for the channel, the UE 402 may determine that the channel is available, and the UE 402 may initiate the channel occupancy and transmit on the channel, such as shown at 414. The time (e.g., period) in which the UE may use/access the channel (e.g., for uplink transmission such as PRACH, PUCCH, PUSCH, uplink reference signals, etc.) after the UE performs the ED or LBT procedure may be referred to as a Channel Occupancy Time (COT) or a UE-initiate d COT.

The UE may share the UE-initiate channel occupancy or COT (e.g., a configured grant (CG)-PUSCH or a scheduled uplink, etc.) with a base station (e.g., the serving base station), such that the base station may be allowed to use the shared channel occupancy to transmit control and/or broadcast signals (or channels) for any UEs as long as the transmission contains one or more transmission(s) for the sharing UE (e.g., UE that initiated the channel occupancy) and/or one or more downlink signals or channels (e.g., PDSCH, PDCCH, reference signals, etc.) meant for the sharing UE.

The ED threshold that the UE applies when initiating the channel occupancy that is to be shared with the base station may be configured by the base station, such as via an RRC signaling. However, if the ED threshold that the UE applies when initiating the channel occupancy that is to be shared with the base station is not configured by the base station, the transmission of the base station within the shared channel occupancy (e.g., the UE initiated COT) may be limited to control or broadcast signals or channels transmissions of up to 2/4/8 OFDM symbols in duration for 15/30/60 kHz SCS. In addition, when the UE and/or the base station is uncertain whether a WiFi is operating within the channel or that the absence of WiFi cannot be assumed based on e.g., regulation, the ED threshold that the base station configures to the UE to apply when the UE initiates the channel occupancy may be determined based on the max transmitting power of the base station. In addition to the ED threshold configured to the UE for the UE-initiated channel occupancy, the UE may also be configured with another ED threshold for normal uplink transmission (e.g., not considering uplink to downlink COT sharing), where the ED threshold for the normal uplink transmission may be determined based on the transmitting power of the UE, such as the maximum transmitting power of the UE.

When the ED threshold for the UE-initiated COT is configured for the UE, the UE may indicate or transmit the COT sharing related information to the base station, such as in a UCI. For example, the UE may provide a row index in an RRC configured table where multiple parameters are jointly encoded. In one example, the multiple parameters may include parameters D, O and channel access priority class (CAPC). The parameter D may represent the number of slots where downlink transmissions may be assumed within the UE-initiated COT. The parameter O may represent a downlink offset that indicates a starting slot of a downlink transmission indicated in number of slots from the end of the slot where the indicated D is greater than zero. The UE may use one row to indicate no COT sharing information.

When the ED threshold for the UE-initiated COT is not configured for the UE, to indicate to the base station whether the UE is sharing the COT, the UE may use a 1-bit indication to indicate if slot or symbol n+X is an applicable slot or symbol for uplink to downlink sharing. The X may be the number of symbols from the end of the slot where the indication is enabled, and the value of X may be configured by the base station as part of the RRC configuration.

As discussed, the value of the ED threshold for the UE may be determined based on the UE or the base station's maximum transmitting power depending on whether there is a COT sharing. For example, when there is no COT sharing, the value of the ED threshold may be determined based on the UE's maximum transmitting power, whereas when there is COT sharing, the value of the ED threshold may be determined based on the base station's maximum transmitting power, etc. Similarly, the value of the ED threshold for the base station may be determined based on the base station's maximum transmitting power (e.g., regardless whether there is a COT sharing). This may reduce the channel access probability for the UE or the base station as the UE or the base station may be configured with the same ED threshold regardless the priority of the data transmitted by the UE or the base station, the channel used by the UE or the base station, and/or type of transmission, etc.

Aspects presented herein may improve the channel access probability for a UE and a base station. Aspects presented herein may enhance the ED threshold determination for the UE and the base station, where the value of the ED threshold is determined based at least in part on one or more characteristic(s) of a transmission, a channel, and/or the UE/base station. As such, the UE and the base station may have easier access to the channel(s) when the data to be transmitted or channel to be used by the UE or the base station is associated with higher priorities. The UE or the base station may also be configured with multiple (e.g., more than two) ED thresholds depending on the scenarios. Note that while aspects below (e.g., Options 1 to 7) may use the UE for illustrations, the aspects may also be applicable to the base station, and shall be construe as part of the disclosure.

In one aspect (e.g., Option 1), the value of the ED threshold for the UE or the base station may be determined based on one or more service type(s) associated with the network, where different ED thresholds may be applied to different network services, such as the eMBB, the mMTC, and/or the URLLC, etc. For example, as shown by Table 1, a network service with higher latency requirement, such as the URLLC, may be configured or assigned with a higher ED threshold (e.g., P₁), whereas a network service with lower latency requirement, such as the eMBB or the mMTC, may be configured or assigned with lower ED thresholds (e.g., P₂ and P₃). The ED thresholds P₁, P₂ and P₃ may have values different from each other, where P₁ may be greater than P₂, and P₂ may be greater P₃, etc.

TABLE 1
Example of Network Service Type and ED Threshold

| Network Service Type | ED Threshold (dB) |
|---|---|
| URLLC | P₁ |
| eMBB | P₂ |
| mMTC | P₃ |

In another aspect (e.g., Option 2), the value of the ED threshold for the UE or the base station may be determined based on the CAPC. The CAPC may be referred to as an LBT priority class, where multiple CAPCs may be defined for a UE and/or a base station for the uplink and/or the downlink LBT procedures. Tables 2A and 2B show examples of CAPC tables that define four LBT priority classes for the downlink and the uplink respectively, and specify the mapping from traffic type (QoS) to LBT priority class. The parameter p may indicate the priority class (e.g., 1, 2, 3, 4, etc.), the parameter mₚ may indicate the number of backoff stages for the corresponding priority class p, the parameter CW_{min,p} and the parameter CW_{max,p} may indicate the minimum and the maximum contention window sizes respectively for the corresponding priority class p, the parameter T_{ulm cot,p} may indicate the maximum channel occupancy time for the corresponding priority class p, and the parameter “Allowed CWₚ, sizes” may indicate the sizes of the contention window that can be selected (e.g., used) for the corresponding priority class p, etc.

TABLE 2A
Example of CAPC with ED Threshold for Downlink

| | | | | | Allowed | |
|---|---|---|---|---|---|---|
| CPAC | | | | | CWₚ | ED |
| (p) | mₚ | CW_{min, p} | CW_{max, p} | T_{ulm cot, p} | s ize s | threshold |
| 1 | 1 | 3 | 7 | 2 ms | {3, 7} | P₁ |
| 2 | 1 | 7 | 15 | 3 ms | {7, 15} | P₂ |
| 3 | 3 | 15 | 63 | 8 ms or 10 ms | {15, 31, | P₃ |
| | | | | | 63} | |
| 4 | 7 | 15 | 1023 | 8 ms or 10 ms | {15, 31, | P₄ |
| | | | | | 63, 127, | |
| | | | | | 255, 511, | |
| | | | | | 1023} | |

TABLE 2B
Example of CAPC with ED Threshold for Uplink

| | | | | | Allowed | |
|---|---|---|---|---|---|---|
| CPAC | | | | | CWₚ | ED |
| (p) | mₚ | CW_{min, p} | CW_{max, p} | T_{ulm cot, p} | s ize s | threshold |
| 1 | 2 | 3 | 7 | 2 ms | {3, 7} | P₁ |
| 2 | 2 | 7 | 15 | 3 ms | {7, 15} | P₂ |
| 3 | 3 | 15 | 1023 | 6 ms or 10 ms | {15, 31, | P₃ |
| | | | | | 63, 127, | |
| | | | | | 255, 511, | |
| | | | | | 1023} | |
| 4 | 7 | 15 | 1023 | 6 ms or 10 ms | {15, 31, | P₄ |
| | | | | | 63, 127, | |
| | | | | | 255, 511, | |
| | | | | | 1023} | |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise T_{ulm cot, p} = 6 ms.
Note2:
When T_{ulm cot, p} = 6 ms it may be increased to 8 ms by inserting one or more gaps. The minimum duration of a gap shall be 100 μs. The maximum duration before including any such gap shall be 6 ms.

To enable the UE and/or the base station to determine the value of the ED threshold based on the priority class (e.g., CAPC), each priority class may be assigned or associated with a respective ED threshold value. For example, as shown by Tables 2A and 2B, an additional ED threshold column may be added to the CAPC tables to indicate different ED thresholds (e.g., P₁, P₂, P₃, P₄) for different priority classes. For example, a first ED threshold P₁ may be used for the first CAPC (e.g., p=1), a second ED threshold P₂ may be used for the second CAPC (e.g., p=2), a third ED threshold P₃ may be used for the third CAPC (e.g., p=3), and a fourth ED threshold P₄ may be used for the fourth CAPC (e.g., p=4), etc. In one example, as the first CAPC may have higher priority than the second, third and fourth CAPC, the value of P₁ may be greater than P₂, P₃, and P₄, and the value of P₂ may be greater P₃ and P₄, and so on, such that P₁>P₂>P₃>P₄. Note that the use of numerals (e.g., 1, 2, 3, 4) in association with each ED threshold does not specify a particular temporal or threshold order, and it merely indicates different ED threshold.

In one other aspect (e.g., Option 3), the value of the ED threshold for the UE or the base station may be determined based on the types of channel, where different types of channel may be associated with different ED thresholds. In one example, control channels may be assigned or configured with a first ED threshold, and the data channels may be assigned or configured with a second ED threshold hold. The ED threshold may be higher for the control channels (e.g., first ED threshold>second ED threshold) or vice versa. The ED threshold may be defined for the uplink transmission (e.g., for the UE) and exclude the downlink transmission. In another example, different ED thresholds may be assigned or configured for different physical channels. As shown by Table 3, where each type of physical channel (e.g., PRACH, SRS, PUCCH, PUSCH, etc.) may be assigned or associated with a corresponding ED threshold value (e.g., P₁, P₂, P₃, P₄). For example, if the PRACH is to be considered to have priority over the SRS, the PUCCH and/or the PUSCH, the value of P₁ may be configured or selected to be greater than P₂, P₃, and P₄, etc. Similarly, the use of numerals (e.g., 1, 2, 3, 4) in association with each ED threshold does not specify a particular temporal or threshold order, and it merely indicates different ED threshold.

TABLE 3
Example of Associating Physical Channels with ED Thresholds

| PRACH | SRS | PUCCH | PUSCH |
|---|---|---|---|
| P₁ | P₂ | P₃ | P₄ |

In one other example, different ED thresholds may be assigned or configured for different logical channels, where ED thresholds may be based on the priority of logical channel (e.g., based on logical channel priority parameter lch-basedPrioritization) and/or the priority of the uplink grant. For examples, control channels (e.g., Dedicated Control Channel (DCCH), Common Control Channel (CCCH)) may be assigned or configured with one ED threshold, and the traffic channels (e.g., Dedicated Traffic Channel (DTCH)) may be configured with another ED threshold, etc. The ED threshold for control channels may be higher than the ED threshold for traffic channels or vice versa.

In one other aspect, (e.g., Option 4), the value of the ED threshold for the UE or the base station may be determined based on the transmission duration (e.g., COT). For example, a shorter transmission duration may be assigned or configured with a first ED threshold, and a longer transmission duration may be assigned or configured with a second ED threshold. In one example, the ED threshold for shorter transmission duration may be higher than the ED threshold for longer transmission duration (e.g., first ED threshold>second ED threshold). Alternatively, different ED thresholds may be assigned or configured for different duration period, such as shown by Table 4. For example, transmissions that are less than 4 ms may be associated with a first ED threshold (e.g., P₁), transmission that is between 4 ms and 8 ms may be associated with a second threshold (e.g., P₂), and transmission that is above 8 ms may be associated with a third threshold (e.g., P₃), etc. The ED thresholds P₁, P₂ and P₃ may have values different from each other, where P₁ may be greater than P₂, and P₂ may be greater P₃, etc.

TABLE 4
Example of Transmission Duration with ED Threshold

| Duration | <4 ms | 4-8 ms | >8 ms |
|---|---|---|---|
| ED Threshold | P₁ | P₂ | P₃ |

In one other aspect, (e.g., Option 5), the value of the ED threshold may be determined based on the instantaneous transmit power, such as the instantaneous transmit power of a UE or a base station. As described previously, the ED threshold may be based on the maximum transmit power of a base station or a UE regardless of the actual transmit power from the base station or the UE. However, if a channel is occupied by a UE or a base station but the power level detected within the channel is lower than the maximum power of the base station or the UE (e.g., the determined ED threshold), the channel may be detected and identified as idle by other UEs as the measured energy level is lower than the ED threshold, which may result in interference if other UEs occupy the channel. Thus, by enabling the base station or the UE to determine or adapt the ED threshold based on the instantaneous transmit power of the base station or the UE, the accuracy of determining whether a channel is occupied may be improved. In one example, as the transmit power of the UE or the base station may be related to or associated with the Transmit Power Control (TPC) command, an ED threshold or an ED threshold adjustment may be configured for each TPC command. For example, after the initial PRACH is detected, the UE power may be dynamically controlled by the TPC command, which means the transmission power of the UE may be controlled by feedback input from the base station. Thus, as shown by Table 5, one or more column (e.g., ED threshold adjustment columns) may be added to the table of the TPC command field, where each TPC command field (e.g., 0, 1, 2, 3, etc.) may be configured or assigned with one or more ED threshold adjustment value(s) (e.g., ΔP_{0,accumalated}, ΔP_{0,absolute}, etc.). The variable δ_{PUSCH} may indicate the TPC command value for the PUSCH, and the variable δ_{SRS} may indicate the TPC command value for the SRS. As shown by Table 5, higher TPC command field may indicate higher transmitting power for δ_{PUSCH} and δ_{SRS}. For example, for the TPC command field 0, the ED threshold adjustment value for the ΔP_{0,accumalated} or the ΔP_{0,absolute} may equal to −1, 0, +1, +3, etc., whereas for TPC command field 3, the ED threshold adjustment value for the ΔP_{0,accumalated} or the ΔP_{0,absolute} may equal to +4, +6, etc.

TABLE 5
Example of Associating TPC Command
with ED Threshold Adjustment

| | Accumulated | | Absolute | |
|---|---|---|---|---|
| TPC | δ_{PUSCH, b, f, c} | ED | δ_{PUSCH, b, f, c} | ED |
| Command | or δ_{SRS, b, f, c} | threshold | or δ_{SRS, b, f, c} | threshold |
| Field | [dB] | adjustment | [dB] | adjustment |
| 0 | −1 | ΔP_{0, accumulated} | −4 | ΔP_{0, absolute} |
| 1 | 0 | ΔP_{1, accumulated} | −1 | ΔP_{1, absolute} |
| 2 | 1 | ΔP_{2, accumulated} | 1 | ΔP_{2, absolute} |
| 3 | 3 | ΔP_{3, accumulated} | 4 | ΔP_{3, absolute} |

In one other example, the ED threshold adjustment value(s) may be configured to be a function of the δ_{PUSCH,b,fc} OR δ_{SRS,b,fc}, rather than equal to the value of them or be a fixed number. For example, the ED threshold may be configured to be proportional to the actual transmission power of the UE based on the TPC command.

In one other aspect, (e.g., Option 6), the value of the ED threshold for the UE or the base station may be determined based on the retransmission or the number of retransmissions. For example, when retransmission occurs, it may mean that the data is important and needs to be successfully transmitted. Thus, the retransmission may use a higher ED threshold than the initial transmission. In other example, if there are more than one retransmissions, the current retransmission may use a higher ED threshold than the previous retransmission. For example, as shown by Table 6, each of the initial transmission or the retransmissions (e.g., first, second, third) may be assigned with a ED threshold (e.g., P₁, P₂, P₃, P₄) where P₄>P₃>P₂>P₁, etc. Thus, the ED threshold may also be determined based on a number n of the retransmission, the ED threshold being higher for an n^{th} retransmission than for an (n−1)^{th} retransmission.

TABLE 6
Example of Associating Transmission/Retransmission
with ED Threshold

| | Transmission | | | |
|---|---|---|---|---|
| | Initial | First | Second | Third |
| | Transmission | Retransmission | Retransmission | Retransmission |
| ED | P₁ | P₂ | P₃ | P₄ |
| Thresh- | | | | |
| old | | | | |

In one other aspect, (e.g., Option 7), the value of the ED threshold for the UE or the base station may be determined based on the importance of a package (e.g., data packet) or based on a priority associated with the package, where a more important package, such as the package associated with a higher priority may use higher ED threshold(s). For example, a voice package may be important and may have performed LBT several times and fail. Thus, a higher ED threshold may be configure d for this voice package to avoid shorter latency. In other words, as there may be a fixed duration between each package, if one of the packages fails the LBT several times (e.g., unable to locate an available channel), the package may exceed the survival time. Thus, a higher ED threshold may be used for the package to avoid package transmission delay. In other example, the ED threshold may be determined based on at least one of latency requirements or quality of service (QoS) requirements that is associated with the package (e.g., transmission), where the ED threshold may be higher when the latency requirements require a faster latency than when the latency requirements require a slower latency or when QoS requirements are higher than when QoS requirements are lower, etc.

There may be one or more ways to configure the ED threshold for the UE or the base station. In one example, the rules and parameters (e.g., Options 1 to 7) for ED thresholds or for determining the ED thresholds may be hard-coded on the UE and the base station. For example, multiple ED thresholds may be hard-coded on a UE or a base station. For a transmission duration of the UE or the base station, the transmission duration may be divided into several levels, where each level may be associated with a corresponding ED threshold or ED threshold rule. In other example, the ED threshold may be determined or configured for the UE via the DCI or the RRC configuration (e.g., by the base station). The number of bits in DCI may depend on the number of ED thresholds configured.

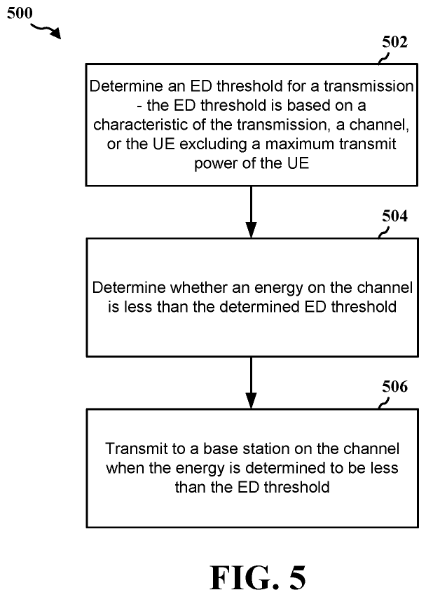

FIG. 5 is a flowchart of a method 500 of wireless communication. The method may be performed by a UE or a component of a UE (e.g., the UE 104, 350, 402; a processing system, which may include the memory 360 and which may be the entire UE 350 or a component of the UE 350, such as the TX processor 368, the RX processor 356, and/or the controller/processor 359). Optional aspects are illustrated with a dashed line. The method may enable the UE to determine ED threshold based on the characteristic of the transmission, the channel or the UE.

At 502, the UE may determine an ED threshold for a transmission, such as discussed in connection with FIG. 4. For example, the UE 402 may determine the ED threshold for a transmission at 406. The ED threshold may be determined based on a characteristic of the transmission, a channel, or the UE excluding a maximum transmit power of the UE, such as discussed in connection with Options 1 to 7.

In one aspect, the ED threshold may be determined based on whether the transmission is URLLC, eMBB, or mMTC, such as discussed in connection with Options 1. The ED threshold may be higher for URLLC than for eMBB or mMTC. In another aspect, the ED threshold may be determined based on a CAPC, such as discussed in connection with Option 2. The ED threshold may be different for each CAPC within a plurality of CAPCs. In another aspect, the ED threshold may be determined based on a type of the channel, such as discussed in connection with Option 3. In one configuration, the ED threshold may be different when the channel is a control channel than when the channel is a data channel. In another configuration, the ED threshold is a first ED threshold P₁ when the channel is a PRACH, a second ED threshold P₂ when the channel is for SRS, a third ED threshold P₃ when the channel is a PUCCH, and a fourth ED threshold P₄ when the channel is a PUSCH. In one other configuration, the ED threshold is determined based on at least one of a priority of the channel or a priority of an UL grant received through the channel. In another aspect, the ED threshold may be determined based on a COT for the transmission, where the ED threshold may be higher for a shorter COT than for a longer COT, such as discussed in connection with Option 4. In one configuration, COTs of the transmission may be divided into a plurality of levels, and the ED threshold may be based on the COT level, with a higher ED threshold for a COT level with short COTs than a COT level with longer COTs. In another aspect, the ED threshold may be determined based on an actual transmission power at which the UE is configured to transmit the transmission, where the actual transmission power may be based on a TPC command received from the base station, such as discussed in connection with Option 5. In one configuration, the ED threshold may be proportional to the actual transmission power based on the TPC command. In another aspect, the ED threshold may be determined based on whether the transmission is a retransmission, such as discussed in connection with Option 6. In one configuration, the ED threshold may be higher when the transmission is a retransmission than when the transmission is an initial transmission. In another configuration, the ED threshold is determined further based on a number n of the retransmission, where the ED threshold is higher for an n^{th} retransmission than for an (n−1)^{th} retransmission. In another aspect, the ED threshold may be determined based on at least one of a priority level associated with a package within the transmission, latency requirements or QoS requirements of the transmission, such as discussed in connection with Option 7. In one configuration, the ED threshold may be higher when the latency requirements require a faster latency than when the latency requirements require a slower latency. In another configuration, the ED threshold may be higher when QoS requirements are higher than when QoS requirements are lower. The ED thresholds (e.g., Options 1 to 7) may be hard-coded on the UE and/or the base station, and the UE may also determine the ED threshold through DCI or RRC configuration.

At 504, the UE may determine whether an energy on the channel is less than the determined ED threshold, such as discussed in connection with FIG. 4. For example, the UE 402 may select a channel and measure the energy of the channel at 408, the UE 402 then compares the measured energy with the ED threshold at 410 and determines whether the measured energy of the channel is less than the determined ED threshold at 412.

At 506, the UE may transmit to a base station on the channel when the energy is determined to be less than the ED threshold, such as discussed in connection with FIG. 4. For example, the UE 402 may initiate channel occupancy for the channel and transmit on the channel at 414.

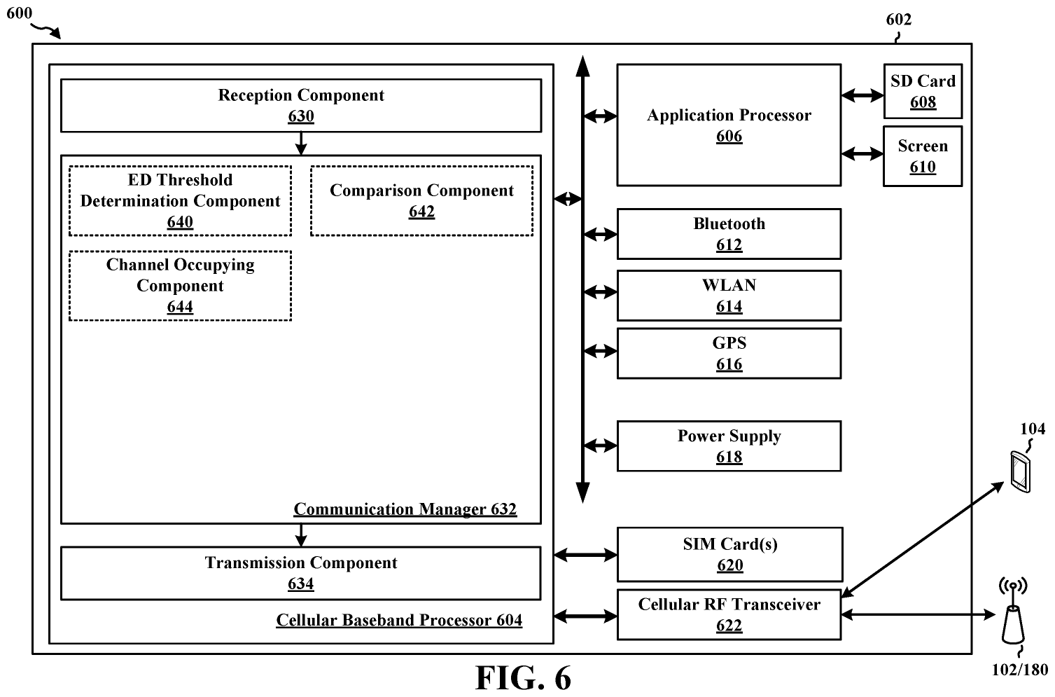

FIG. 6 is a diagram 600 illustrating an example of a hardware implementation for an apparatus 602. The apparatus 602 is a UE and includes a cellular baseband processor 604 (also referred to as a modem) coupled to a cellular RF transceiver 622 and one or more subscriber identity modules (SIM) cards 620, an application processor 606 coupled to a secure digital (SD) card 608 and a screen 610, a Bluetooth module 612, a wireless local area network (WLAN) module 614, a Global Positioning System (GPS) module 616, and a power supply 618. The cellular baseband processor 604 communicates through the cellular RF transceiver 622 with the UE 104 and/or BS 102/180. The cellular baseband processor 604 may include a computer-readable medium/memory. The computer-readable medium/memory may be non-transitory. The cellular baseband processor 604 is responsible for general processing, including the execution of software stored on the computer-readable medium/memory. The software, when executed by the cellular baseband processor 604, causes the cellular baseband processor 604 to perform the various functions described supra. The computer-readable medium/memory may also be used for storing data that is manipulated by the cellular baseband processor 604 when executing software. The cellular baseband processor 604 further includes a reception component 630, a communication manager 632, and a transmission component 634. The communication manager 632 includes the one or more illustrated components. The components within the communication manager 632 may be stored in the computer-readable medium/memory and/or configured as hardware within the cellular baseband processor 604. The cellular baseband processor 604 may be a component of the UE 350 and may include the memory 360 and/or at least one of the TX processor 368, the RX processor 356, and the controller/processor 359. In one configuration, the apparatus 602 may be a modem chip and include just the baseband processor 604, and in another configuration, the apparatus 602 may be the entire UE (e.g., see 350 of FIG. 3) and include the aforediscussed additional modules of the apparatus 602.

The communication manager 632 includes a component 640 that is configured to determine an ED threshold for a transmission, where the ED threshold is based on a characteristic of the transmission, a channel, or the UE excluding a maximum transmit power of the UE, e.g., as described in connection with 502 of FIG. 5. The communication manager 632 further includes a component 642 that is configured to determine whether an energy on the channel is less than the determined ED threshold, e.g., as described in connection with 504 of FIG. 5. The communication manager 632 further includes a component 644 that is configured to transmit to a base station on the channel when the energy is determined to be less than the ED threshold, e.g., as described in connection with 506 of FIG. 5.

The apparatus may include additional components that perform each of the blocks of the algorithm in the aforementioned flowchart of FIG. 5. As such, each block in the aforementioned flowchart of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof. In one configuration, the apparatus 602, and in particular the cellular baseband processor 604, includes means for determining an ED threshold for a transmission, where the ED threshold is based on a characteristic of the transmission, a channel, or the UE excluding a maximum transmit power of the UE. The apparatus 602 includes means for determining whether an energy on the channel is less than the determined ED threshold. The apparatus 602 includes means for transmitting to a base station on the channel when the energy is determined to be less than the ED threshold.

In one configuration, the ED threshold may be determined based on whether the transmission is URLLC, eMBB, or mMTC. For example, the ED threshold may be higher for URLLC than for eMBB or mMTC.

In one configuration, the ED threshold may be determined based on a CAPC. For example, the ED threshold may be different for each CAPC within a plurality of CAPCs.

In one configuration, the ED threshold may be determined based on a type of the channel. In such configuration, the ED threshold may be different when the channel is a control channel than when the channel is a data channel. In such configuration, the ED threshold is a first ED threshold P₁ when the channel is a PRACH, a second ED threshold P₂ when the channel is for SRS, a third ED threshold P₃ when the channel is a PUCCH, and a fourth ED threshold P₄ when the channel is a PUSCH. In one other example, the ED threshold is determined based on at least one of a priority of the channel or a priority of an UL grant received through the channel.

In one configuration, the ED threshold may be determined based on a COT for the transmission, where the ED threshold may be higher for a shorter COT than for a longer COT. In such configuration, COTs of the transmission may be divided into a plurality of levels, and the ED threshold may be based on the COT level, with a higher ED threshold for a COT level with short COTs than a COT level with longer COTs.

In one configuration, the ED threshold may be determined based on an actual transmission power at which the UE is configured to transmit the transmission, where the actual transmission power may be based on a TPC command received from the base station. In such configuration, the ED threshold may be proportional to the actual transmission power based on the TPC command.

In one configuration, the ED threshold may be determined based on whether the transmission is a retransmission. In such configuration, the ED threshold may be higher when the transmission is a retransmission than when the transmission is an initial transmission. In such configuration, the ED threshold is determined further based on a number n of the retransmission, where the ED threshold is higher for an n^{th} retransmission than for an (n−1)^{th} retransmission.

In one configuration, the ED threshold may be determined based on at least one of a priority level associated with a package within the transmission, latency requirements or QoS requirements of the transmission. In such configuration, the ED threshold may be higher when the latency requirements require a faster latency than when the latency requirements require a slower latency. In such configuration, the ED threshold may be higher when QoS requirements are higher than when QoS requirements are lower.

The ED thresholds may be hard-coded on the UE and/or the base station, and the UE may also determine the ED threshold through DCI or RRC configuration. The aforementioned means may be one or more of the aforementioned components of the apparatus 602 configured to perform the functions recited by the aforementioned means. As described supra, the apparatus 602 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

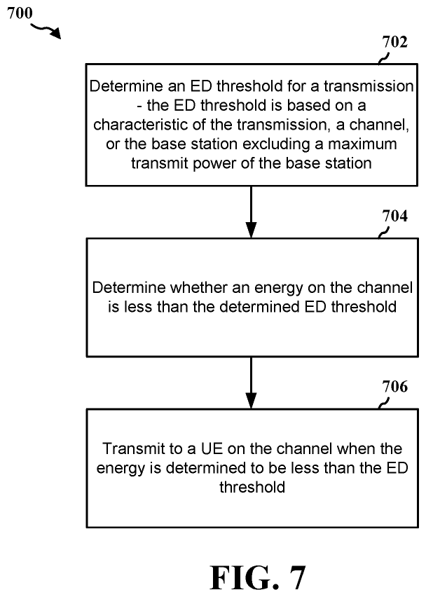

FIG. 7 is a flowchart 700 of a method of wireless communication. The method may be performed by a base station or a component of a base station (e.g., base station 102, 180, 310; which may include the memory 376 and which may be the entire base station 310 or a component of the base station 310, such as the TX processor 316, the RX processor 370, and/or the controller/processor 375). Optional aspects are illustrated with a dashed line. The method may enable the base station to determine ED threshold based on the characteristic of the transmission, the channel or the base station.

At 702, the base station may determine an ED threshold for a transmission. The ED threshold may be determined based on a characteristic of the transmission, a channel, or the base station excluding a maximum transmit power of the base station, such as discussed in connection with Options 1 to 7.

In one aspect, the ED threshold may be determined based on whether the transmission is URLLC, eMBB, or mMTC, such as discussed in connection with Options 1. The ED threshold may be higher for URLLC than for eMBB or mMTC. In another aspect, the ED threshold may be determined based on a CAPC, such as discussed in connection with Option 2. The ED threshold may be different for each CAPC within a plurality of CAPCs. In another aspect, the ED threshold may be determined based on a type of the channel, such as discussed in connection with Option 3. In one configuration, the ED threshold may be different when the channel is a control channel than when the channel is a data channel. In one other configuration, the ED threshold is determined based on at least one of a priority of the channel. In another aspect, the ED threshold may be determined based on a COT for the transmission, where the ED threshold may be higher for a shorter COT than for a longer COT, such as discussed in connection with Option 4. In one configuration, COTs of the transmission may be divided into a plurality of levels, and the ED threshold may be based on the COT level, with a higher ED threshold for a COT level with short COTs than a COT level with longer COTs. In another aspect, the ED threshold may be determined based on an actual transmission power at which the base station is configured to transmit the transmission, where the actual transmission power may be based on a TPC command, such as discussed in connection with Option 5. In one configuration, the ED threshold may be proportional to the actual transmission power based on the TPC command. In another aspect, the ED threshold may be determined based on whether the transmission is a retransmission, such as discussed in connection with Option 6. In one configuration, the ED threshold may be higher when the transmission is a retransmission than when the transmission is an initial transmission. In another configuration, the ED threshold is determined further based on a number n of the retransmission, where the ED threshold is higher for an n^{th} retransmission than for an (n−1)^{th} retransmission. In another aspect, the ED threshold may be determined based on at least one of a priority level associated with a package within the transmission, latency requirements or QoS requirements of the transmission, such as discussed in connection with Option 7. In one configuration, the ED threshold may be higher when the latency requirements require a faster latency than when the latency requirements require a slower latency. In another configuration, the ED threshold may be higher when QoS requirements are higher than when QoS requirements are lower. The ED thresholds (e.g., Options 1 to 7) may be hard-coded on the base station.

At 704, the base station may determine whether an energy on the channel is less than the determined ED threshold.

At 706, the base station may transmit to a UE on the channel when the energy is determined to be less than the ED threshold.

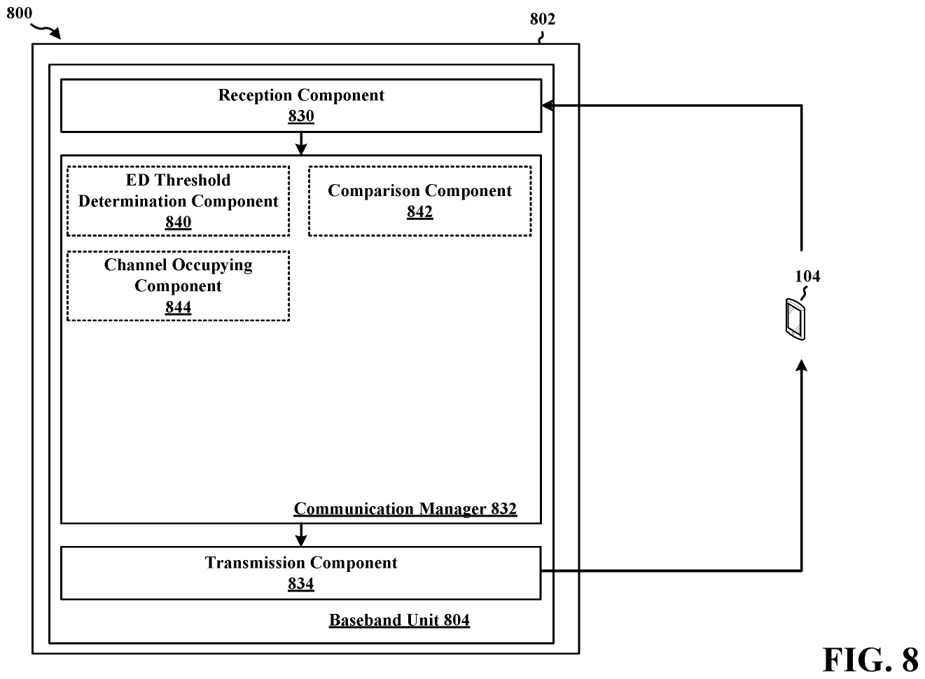

FIG. 8 is a diagram 800 illustrating an example of a hardware implementation for an apparatus 802. The apparatus 802 is abase station and includes a baseband unit 804. The baseband unit 804 may communicate through a cellular RF transceiver with the UE 104. The baseband unit 804 may include a computer-readable medium/memory. The baseband unit 804 is responsible for general processing, including the execution of software stored on the computer-readable medium/memory. The software, when executed by the baseband unit 804, causes the baseband unit 804 to perform the various functions described supra. The computer-readable medium/memory may also be used for storing data that is manipulated by the baseband unit 804 when executing software. The baseband unit 804 further includes a reception component 830, a communication manager 832, and a transmission component 834. The communication manager 832 includes the one or more illustrated components. The components within the communication manager 832 may be stored in the computer-readable medium/memory and/or configured as hardware within the baseband unit 804. The baseband unit 804 may be a component of the BS 310 and may include the memory 376 and/or at least one of the TX processor 316, the RX processor 370, and the controller/processor 375.

The communication manager 832 includes a component 840 that is configured to determine an ED threshold for a transmission, where the ED threshold is based on a characteristic of the transmission, a channel, or the base station excluding a maximum transmit power of the base station, e.g., as described in connection with 702 of FIG. 7. The communication manager 832 further includes a component 842 that is configured to determine whether an energy on the channel is less than the determined ED threshold, e.g., as described in connection with 704 of FIG. 7. The communication manager 832 further includes a component 844 that is configured to transmit to a UE on the channel when the energy is determined to be less than the ED threshold, e.g., as described in connection with 706 of FIG. 7.

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof. In one configuration, the apparatus 802, and in particular the baseband unit 804, includes means for determining an ED threshold for a transmission, where the ED threshold is based on a characteristic of the transmission, a channel, or the base station excluding a maximum transmit power of the base station. The apparatus 802 includes means for determining whether an energy on the channel is less than the determined ED threshold. The apparatus 802 includes means for transmitting to a UE on the channel when the energy is determined to be less than the ED threshold.

In one configuration, the ED threshold may be determined based on whether the transmission is URLLC, eMBB, or mMTC. For example, the ED threshold may be higher for URLLC than for eMBB or mMTC.

In one configuration, the ED threshold may be determined based on a CAPC. For example, the ED threshold may be different for each CAPC within a plurality of CAPCs.

In one configuration, the ED threshold may be determined based on a type of the channel. In such configuration, the ED threshold may be different when the channel is a control channel than when the channel is a data channel.

In one configuration, the ED threshold may be determined based on a COT for the transmission, where the ED threshold may be higher for a shorter COT than for a longer COT. In such configuration, COTs of the transmission may be divided into a plurality of levels, and the ED threshold may be based on the COT level, with a higher ED threshold for a COT level with short COTs than a COT level with longer COTs.

In one configuration, the ED threshold may be determined based on an actual transmission power at which the base station is configured to transmit the transmission.

In one configuration, the ED threshold may be determined based on whether the transmission is a retransmission. In such configuration, the ED threshold may be higher when the transmission is a retransmission than when the transmission is an initial transmission. In such configuration, the ED threshold is determined further based on a number n of the retransmission, where the ED threshold is higher for an n^{th} retransmission than for an (n−1)^{th} retransmission.

In one configuration, the ED threshold may be determined based on at least one of a priority level associated with a package within the transmission, latency requirements or QoS requirements of the transmission. In such configuration, the ED threshold may be higher when the latency requirements require a faster latency than when the latency requirements require a slower latency. In such configuration, the ED threshold may be higher when QoS requirements are higher than when QoS requirements are lower.

The ED thresholds may be hard-coded on the UE and/or the base station. The aforementioned means may be one or more of the aforementioned components of the apparatus 802 configured to perform the functions recited by the aforementioned means. As described supra, the apparatus 802 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Aspects of the present disclosure enhance the determination of ED threshold to improve the channel access probability of the UE, where the UE may determine the ED threshold based on the characteristic of the transmission, the channel, and/or the UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication of a user equipment (UE), comprising:
determining an energy detection (ED) threshold for a transmission, the ED threshold being based on a characteristic of the transmission, a channel, or the UE excluding a maximum transmit power of the UE;
determining whether an energy on the channel is less than the determined ED threshold; and
transmitting to a base station on the channel when the energy is determined to be less than the ED threshold.

2. The method of claim 1, wherein the ED threshold is determined based on whether the transmission is ultra-reliable low latency communication (URLLC), enhanced mobile broadband (eMBB), or massive machine type communication (mMTC).

3. (canceled)

4. The method of claim 1, wherein the ED threshold is determined based on a channel access priority class (CAPC).

5. (canceled)

6. The method of claim 1, wherein the ED threshold is determined based on a type of the channel.

7. The method of claim 6, wherein ED threshold is different when the channel is a control channel than when the channel is a data channel.

8. The method of claim 6, wherein the ED threshold is a first ED threshold P₁ when the channel is a physical random access channel (PRACH), a second ED threshold P₂ when the channel is for sounding reference signals (SRS), a third ED threshold P₃ when the channel is a physical uplink control channel (PUCCH), and a fourth ED threshold P₄ when the channel is a physical uplink shared channel (PUSCH).

9. The method of claim 6, wherein the ED threshold is determined based on at least one of a priority of the channel or a priority of an uplink (UL) grant received through the channel.

10. The method of claim 6, wherein the ED threshold is determined based on a channel occupancy time (COT) for the transmission, the ED threshold being higher for a shorter COT than for a longer COT.

11. (canceled)

12. The method of claim 1, wherein the ED threshold is determined based on an actual transmission power at which the UE is configured to transmit the transmission, the actual transmission power being based on a transmission power control (TPC) command received from the base station.

13. (canceled)

14. The method of claim 1, wherein the ED threshold is determined based on whether the transmission is a retransmission.

15. (canceled)

16. The method of claim 14, wherein the ED threshold is determined further based on a number n of the retransmission, the ED threshold being higher for an n^{th} retransmission than for an (n−1)^{th} retransmission.

17. The method of claim 1, wherein the ED threshold is determined based on at least one of a priority level associated with a package within the transmission, latency requirements or quality of service (QoS) requirements of the transmission.

18. (canceled)

19. (canceled)

20. The method of claim 1, wherein the ED threshold is determined further based on at least one of hard-code, downlink control information (DCI), or a radio resource control (RRC) configuration.

21. An apparatus for wireless communication, comprising:
a memory; and
at least one processor coupled to the memory and configured to:
determine an energy detection (ED) threshold for a transmission, the ED threshold being based on a characteristic of the transmission, a channel, or a UE excluding a maximum transmit power of the UE;
determine whether an energy on the channel is less than the determined ED threshold; and
transmit to a base station on the channel when the energy is determined to be less than the ED threshold.

22. The apparatus of claim 21, wherein the ED threshold is determined based on whether the transmission is ultra-reliable low latency communication (URLLC), enhanced mobile broadband (eMBB), or massive machine type communication (mMTC).

23. The apparatus of claim 22, wherein the ED threshold is higher for URLLC than for eMBB or mMTC.

24. The apparatus of claim 21, wherein the ED threshold is determined based on a channel access priority class (CAPC).

25. The apparatus of claim 24, wherein the ED threshold is different for each CAPC within a plurality of CAPCs.

26. The apparatus of claim 21, wherein the ED threshold is determined based on a type of the channel.

27. The apparatus of claim 26, wherein ED threshold is different when the channel is a control channel than when the channel is a data channel.

28. The apparatus of claim 26, wherein the ED threshold is a first ED threshold P₁ when the channel is a physical random access channel (PRACH), a second ED threshold P₂ when the channel is for sounding reference signals (SRS), a third ED threshold P₃ when the channel is a physical uplink control channel (PUCCH), and a fourth ED threshold P₄ when the channel is a physical uplink shared channel (PUSCH).

29. The apparatus of claim 26, wherein the ED threshold is determined based on at least one of a priority of the channel or a priority of an uplink (UL) grant received through the channel.

30. The apparatus of claim 26, wherein the ED threshold is determined based on a channel occupancy time (COT) for the transmission, the ED threshold being higher for a shorter COT than for a longer COT.

31. The apparatus of claim 30, wherein COTs of the transmission are divided into a plurality of levels, and the ED threshold is based on the COT level, with a higher ED threshold for a COT level with short COTs than a COT level with longer COTs.

32. The apparatus of claim 21, wherein the ED threshold is determined based on an actual transmission power at which the UE is configured to transmit the transmission, the actual transmission power being based on a transmission power control (TPC) command received from the base station.

33. The apparatus of claim 32, wherein the ED threshold is proportional to the actual transmission power based on the TPC command.

34. The apparatus of claim 21, wherein the ED threshold is determined based on whether the transmission is a retransmission.

35. The apparatus of claim 34, wherein the ED threshold is higher when the transmission is a retransmission than when the transmission is an initial transmission.

36. The apparatus of claim 34, wherein the ED threshold is determined further based on a number n of the retransmission, the ED threshold being higher for an n^{th} retransmission than for an (n−1)^{th} retransmission.

37. The apparatus of claim 21, wherein the ED threshold is determined based on at least one of a priority level associated with a package within the transmission, latency requirements or quality of service (QoS) requirements of the transmission.

38. The apparatus of claim 37, wherein the ED threshold is higher when the latency requirements require a faster latency than when the latency requirements require a slower latency.

39. The apparatus of claim 37, wherein the ED threshold is higher when QoS requirements are higher than when QoS requirements are lower.

40. The apparatus of claim 21, wherein the ED threshold is determined further based on at least one of hard-code, downlink control information (DCI), or a radio resource control (RRC) configuration.

41. An apparatus for wireless communication, comprising:
means for determining an energy detection (ED) threshold for a transmission, the ED threshold being based on a characteristic of the transmission, a channel, or a UE excluding a maximum transmit power of the UE;
means for determining whether an energy on the channel is less than the determined ED threshold; and
means for transmitting to a base station on the channel when the energy is determined to be less than the ED threshold.

42-60. (canceled)

61. A computer-readable medium storing computer executable code, the code when executed by a processor cause the processor to:
determine an energy detection (ED) threshold for a transmission, the ED threshold being based on a characteristic of the transmission, a channel, or a UE excluding a maximum transmit power of the UE;
determine whether an energy on the channel is less than the determined ED threshold; and
transmit to a base station on the channel when the energy is determined to be less than the ED threshold.
